(19) United States
(12) Patent Application Publication
(10) Pub. No.: US 2017/0241435 A1
(43) Pub. Date: Aug. 24, 2017

(54) SYSTEMS AND METHODS FOR STIFFENING CASES ON GAS-TURBINE ENGINES

(71) Applicant: United Technologies Corporation, Hartford, CT (US)

(72) Inventor: Scot A. Webb, Gales Ferry, CT (US)

(73) Assignee: United Technologies Corporation, Hartford, CT (US)

(21) Appl. No.: 15/051,377

(22) Filed: Feb. 23, 2016

(51) Int. Cl. F04D 29/52; F04D 29/64; F04D 19/00; F02C 3/04

(52) U.S. Cl. CPC F04D 29/526; F02C 3/04; F04D 29/644; F04D 19/00; F05D 2220/32; F05D 2240/35

(57) ABSTRACT

An engine case may include a first half and a second half. The first half may have a semiannular geometry with a first flange located at a circumferential edge of the first half. The second half may also have a semiannular geometry. The second half may further include a flange located at a circumferential edge of the first half. The second flange may be aligned with the first flange and mechanically coupled to the first flange. The first flange and the second flange may be configured to substantially align with an engine mounting point. The engine case may also have an annular geometry.

### FIELD

The disclosure relates generally to gas turbine engines, and more particularly to the engine compressor case structure and maintaining tip clearances.

### BACKGROUND

Gas turbine engines include various rotating airfoil sections in which the tip clearance (e.g., the gap) between the blade tips and the case opposite the blade tips impacts engine performance. Variance in tip clearances and larger tip clearances designed to accommodate clearance fluctuation typically reduce engine performance in terms of stall margin, power output, and efficiency, for example.

As a result, compressors in gas turbine engines are dependent on controlling blade tip clearances to maintain compressor efficiency and operability. One aspect of controlling tip clearances is to minimize the out-of-round deflection of the compressor cases.

### SUMMARY

According to various embodiments, an engine case to provide structural stiffening is provided. An engine case may include a first half and a second half. The first half may have a semiannular geometry with a first flange located at a circumferential edge of the first half. The second half may also have a semiannular geometry. The second half may further include a flange located at a circumferential edge of the second half. The second flange may be aligned with the first flange and mechanically coupled to the first flange. The first flange and the second flange may be configured to substantially align with an engine mounting point. The engine case may also have an annular geometry. Typical gas turbine construction has the compressor case split flange oriented on a horizontal plane. In an engine where the engine thrust mount is situated vertically above the engine centerline, a split flange oriented on a horizontal plane will be on the neutral bending axis of the engine and will not influence the case bending stiffness nor out of round deflection. This invention preferably orients the split flange in such an engine on the vertical plane, where by virtue of the parallel axis theorem of mechanics the flange will substantively increase the case stiffness for bending and will reduce out of round deflection.

In various embodiments, the engine case may be a high pressure compressor case. The engine case may include a third flange located at a circumferential edge of the first half, and a fourth flange located at a circumferential edge of the second half. The third flange may be aligned with the fourth flange and mechanically coupled to the fourth flange. The engine case may also include a first seam defined by the first flange and the second flange, and a second seam defined by the third flange and the fourth flange. The first seam may be vertically aligned with the second seam. A fastener may mechanically couple the first flange to the second flange. The first flange may extend axially along the first half to define a mating surface. The mating surface may be coplanar with an engine centerline. The third flange may define a second mating surface that is coplanar with the first mating surface.

A gas turbine engine is also provided. The engine may include a compressor section configured rotate about an axis and a combustor aft of the compressor section and in fluid communication with the compressor section. A turbine section may be disposed aft of the combustor and configured to extract energy from combusted gas exiting from the combustor section. An engine mounting point may be located at a top of the gas turbine engine. A case disposed about the compressor section with the case including a first half with a first upper flange and a second half with a second upper flange. The first upper flange may be mechanically coupled to the second upper flange. The first upper flange may be substantially aligned with the engine mounting point.

In various embodiments, the gas turbine engine may also include a first lower flange extending from the first half of the case, and a second lower flange extending from the second half of the case. The first lower flange may be mechanically coupled to the second lower flange. The first upper flange and the first lower flange may be coplanar. The first upper flange may also be diametrically opposite the first lower flange. The first upper flange and the axis may also be coplanar. The case may be at least partially disposed about a high pressure compressor of the compressor section. The first upper flange may extend axially along an edge of the first half of the case. The first upper flange may also define a mating surface.

A compressor section is also provided. The compressor section may include a high pressure compressor configured to rotate about an axis and a case. The case may have an annular geometry and be disposed about the high pressure compressor. The case may include a first half having a first flange extending axially and a second half having a second flange extending axially. The first flange may be mechanically coupled to the second flange. The first flange and the second flange may be configured to substantially align with an engine mounting point.

In various embodiments, the first flange may be coplanar with the axis. The compressor section may also include a third flange extending axially along the first half, and a fourth flange extending axially along the second half. The third flange may be mechanically coupled to the fourth flange. The first flange may also be diametrically opposite the third flange.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 illustrates a cross sectional view of an exemplary gas turbine engine, in accordance with various embodiments;

FIG. 2 illustrates an exploded view of an engine case from forward looking aft, in accordance with various embodiments;

FIG. 3 illustrates a perspective view of a portion of an engine case half, in accordance with various embodiments; and

FIG. 4 illustrates a perspective view of an engine case having two halves with flanges aligned on a vertical plane, in accordance with various embodiments.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the disclosures, it should be understood that other embodiments may be realized and that logical, chemical, and mechanical changes may be made without departing from the spirit and scope of the disclosures. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “aft” refers to the direction associated with the tail (e.g., the back end) of an aircraft, or generally, to the direction of exhaust of the gas turbine. As used herein, “forward” refers to the direction associated with the nose (e.g., the front end) of an aircraft, or generally, to the direction of flight or motion.

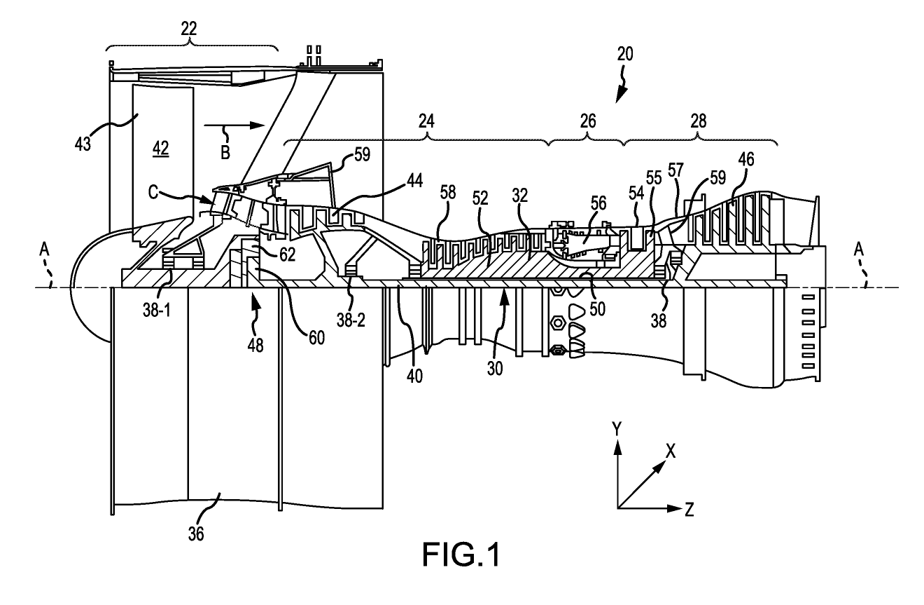

In various embodiments and with reference to FIG. 1, a gas-turbine engine 20 is provided. Gas-turbine engine 20 may be a two-spool turbofan that generally incorporates a fan section 22, a compressor section 24, a combustor section 26 and a turbine section 28. Alternative engines may include, for example, an augmentor section among other systems or features. In operation, fan section 22 can drive the working fluid along a bypass flow-path B while compressor section 24 can drive the working fluid along a core flow-path C for compression and communication into combustor section 26 then expansion through turbine section 28. Although depicted as a two-spool turbofan gas-turbine engine 20 herein, it should be understood that the concepts described herein are not limited to use with two-spool turbofans as the teachings may be applied to other types of turbine engines including three-spool architectures.

Gas-turbine engine 20 may generally comprise a low speed spool 30 and a high speed spool 32 mounted for rotation about an engine central longitudinal axis A-A′ relative to an engine static structure 36 via several bearing systems 38, 38-1, and 38-2. Engine central longitudinal axis A-A′ is oriented in the z direction on the provided xyz axis. It should be understood that various bearing systems 38 at various locations may alternatively or additionally be provided, including for example, bearing system 38, bearing system 38-1, and bearing system 38-2. In various embodiments, bearing system 38, bearing system 38-1, and bearing system 38-2 may be contained within a bearing housing and/or integrated into an oil delivery system, as described in further detail below.

Low speed spool 30 may generally comprise an inner shaft 40 that interconnects a fan 42, a low pressure (or first) compressor section 44 and a low pressure (or first) turbine section 46. Inner shaft 40 may be connected to fan 42 through a geared architecture 48 that can drive fan 42 at a lower speed than low speed spool 30. Geared architecture 48 may comprise a gear assembly 60 enclosed within a gear housing 62. Gear assembly 60 couples inner shaft 40 to a rotating fan structure. High speed spool 32 may comprise an outer shaft 50 that interconnects a high pressure (or second) compressor 52 and high pressure (or second) turbine 54. A combustor 56 may be located between high pressure compressor 52 and high pressure turbine 54.

A mid-turbine frame 57 of engine static structure 36 may be located generally between high pressure turbine 54 and low pressure turbine 46. Mid-turbine frame 57 may support one or more bearing systems 38 in turbine section 28. Inner shaft 40 and outer shaft 50 may be concentric and rotate via bearing systems 38 about the engine central longitudinal axis A-A′, which is collinear with their longitudinal axes. As used herein, a “high pressure” compressor or turbine experiences a higher pressure than a corresponding “low pressure” compressor or turbine.

The core airflow C may be compressed by fan section 42 then low pressure compressor section 44 then high pressure compressor 52, mixed and burned with fuel in combustor 56, then expanded over high pressure turbine 54 and low pressure turbine 46. Turbines 46, 54 rotationally drive the respective low speed spool 30, fan 42, and high speed spool 32 in response to the expansion.

In various embodiments, engine static structure 36 may include a compressor case 58 (i.e., a split case disposed about high pressor compressor 52) disposed about a portion of compressor section 24. A portion of compressor case 58 is cutaway in FIG. 1 to illustrate components compressor section 24 retained within compressor case 58, however, compressor case 58 may circumferentially enclose at least a portion of compressor section 24 and provide structural support. Compressor case 58 may, for example, enclose high pressure compressor 52. Compressor case 58 may include one or more axial splits substantially parallel to axis A-A′ (and the z axis as illustrated). The axial splits may be selectively oriented circumferentially to provide stiffening in a preferred plane. In typical top mounted engines (e.g., engines where the mounting point 59 is above axis A-A′ in the y direction, as illustrated), the split may be oriented vertically (e.g., with seams aligned in the y direction) to provide case stiffness. In such cases, engine mounting point 59 may be a thrust mount located forward of high pressure compressor 52. The thrust mount (at mounting point 59) may be located at the top of the gas turbine engine. The top of the engine may be described as the side of the engine furthest from the ground while the aircraft is on the ground. In that regard, as explained in greater detail below, the seams and flanges of compressor case 58 may be substantially aligned with mounting point 59 at the top of the engine.

Although aircraft and top-mounted engines are described in detail herein, various embodiments may include non-aircraft installations with varied mounting points. The split flanges on engine cases may be oriented relative to a moment applied to the engine to reduce out-of-round deflections. In traditional top-mounted aircraft installations the split flanges will typically thus be oriented in a vertical plane; however, non-vertical orientations may be appropriate in engines with varied mounting structures.

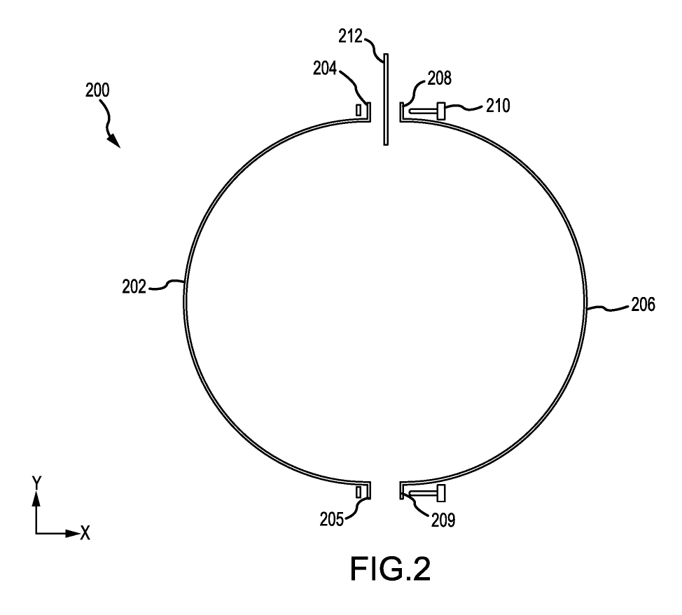

With reference to FIG. 2, an exploded view of an engine case 200 from forward looking aft is shown, in accordance with various embodiments. Engine case 200 may be, for example, a high-pressure-compressor case, a low-pressure-compressor case, a high-pressure-turbine case, or a low-pressure turbine case. Engine case 200 may be an annular shaped structure having two or more portions. Engine case 200) may be configured to retain rotating turbomachinery. The circular profile of engine case 200 may encase or surround the rotational path of a rotating compressor or turbine blade about an engine centerline such as the axis A-A′ in FIG. 1, for example. In that regard, engine case 200 may be substantially centered about the engine centerline.

In various embodiments, engine case 200 may include a first case 202 and a second case 206. The left half may include an upper flange 204 and a lower flange 205. The upper flange 204 and lower flange 205 may be located approximately 180° from one another. Stated another way, the upper flange 204 and lower flange 205 may be diametrically opposite one another. Upper and lower flanges may be upper and lower relative to the ground when a plane is on the runway. In that regard, an upper flange may be near the point of the engine furthest from the ground (e.g., near the top of the engine relative to the ground). A lower flange may be near the point of the engine closest to the ground while a plane is on the runway (e.g., near the bottom of the engine).

In various embodiments, upper flange 204 and lower flange 205 may be oriented such that the engine mounting points (represented by mounting support location 212) are located axially from the upper flange 204 and diametrically opposite lower flange 205. Stated another way, upper flange 204 may be closer to engine mounting points in a circumferential direction than lower flange 205. In a typical engine installation, with engine mounting points at or near the top of the engine (e.g., the portion of the engine furthest from the ground) in the y direction, upper flange 204 and lower flange 205 may be aligned in the vertical plane (i.e., the y-z plane). The flanges may thus be oriented at top-dead center and bottom-dead center of an engine case as viewed from the ground while a plane is on the runway.

In various embodiments, engine case 200 may also include second half 206. Second half 206 may have upper flange 208 and lower flange 209. Upper flange 208 may be similar to upper flange 204. Lower flange 209 may also be similar to lower flange 205. Lower flange 209 may be pressed against lower flange 205 and upper flange 204 may be pressed against upper flange 208. Fasteners 210 may be passed through the upper flanges and the lower flanges to mechanically couple the first half 202 to the second half 206. The seam between the upper flanges may be vertically aligned (e.g., in the y direction) with the seam between the lower flanges. Fasteners 210 may include rivets, bolts, or other suitable fasteners to couple the first half 202 and second half 206 along the flanges. In response to the flanges being mechanically coupled, engine case 200 may form an annulus.

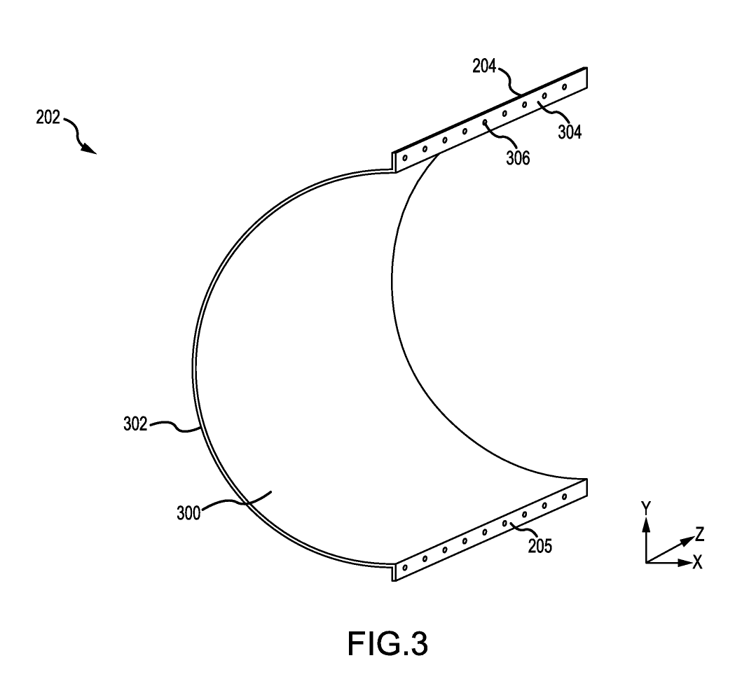

With reference to FIG. 3, a perspective view of first half 202 of engine case 200 is shown, in accordance with various embodiments. Although first half 202 is illustrated, second half 206 shares the same characteristics of first half 202 described herein. First half 202 of engine case 200 may include a semi-circular edge 302 in the x-v plane. A body of first half 202 of engine case 200 may extend aft from semi-circular edge 302 (e.g., in the z direction). Upper flange 204 and lower flange 205 may extend in the z direction at the circumferential edges of semi-circular edge 302.

In various embodiments, upper flange 204 and lower flange 205 may be substantially rectangular and comprise mating surfaces 304 in the y-z plane. The flat mating surfaces may extend the length of first half 202 in the z direction. The flat mating surfaces may also be limited in length and partially extend the length of first half 202 in the z direction. Mating surface 304 of first half 202 may be configured to mate with corresponding mating surfaces of second half 206. Mating surface 304 may define openings 306 configured to receive fasteners 210 from FIG. 2. Openings 306 in mating surface 304 may align with corresponding openings defined by the mating surface of second half 206. Referring briefly to FIG. 2, first half 202 and second half 206 may thus be pressed together in the x direction with the mating surface 304 of second half 202 aligned with the corresponding mating surface of first half 206.

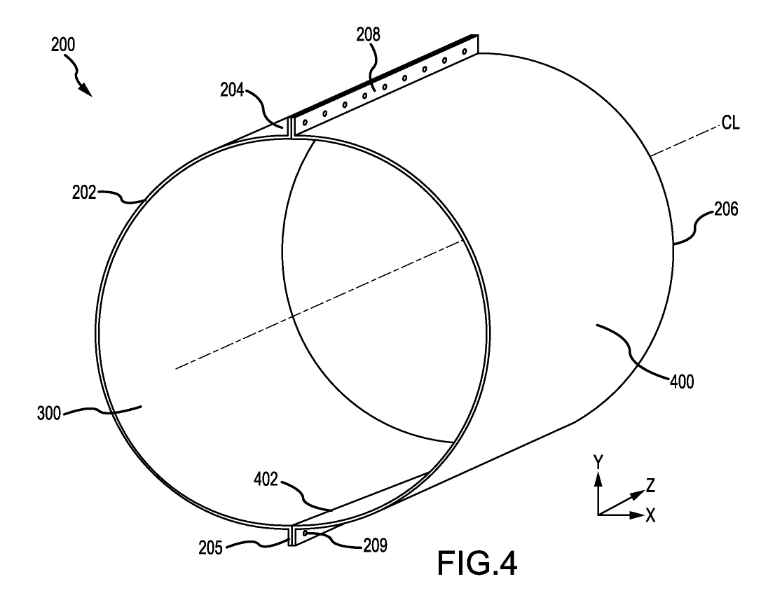

Referring now to FIG. 4, a perspective view of engine case 200 substantially centered about engine centerline CL with the potential for out-of-round deflection or other deflection resultant from engine operation. Body 300 of first half 202 and body 400 of second half 206 from the inner surface of the annular geometry with seam 402 between lower flange 205 and lower flange 209 substantially aligned in the y direction with the seam between upper flange 204 and upper flange 208. The engine mounting points may be substantially aligned with the same vertical plane as the flange seams (i.e., the y-z plane). Substantially aligned, as used to describe circumferential alignment between engine mounting points and the flanges of engine case 200 such that the engine mounting points are within 15° of circumferential arc from upper flange 204, upper flange 208, lower flange 205, and/or lower flange 209, as measured from the engine centerline. Although substantially aligned circumferentially, as described above, in various embodiments the engine mounting points may be offset from engine case 200 in an axial direction.

The axially oriented upper flanges and lower flanges of engine case 200 may serve as a pair of axial stiffening ribs on, for example, a high pressure compressor case. By orienting the flanges in the vertical plane, for example, on engines with top located mounting points, the flanges serve as stiffening ribs in the plane in which the thrust/thrust mount couple (i.e., mounting point 59 of FIG. 1) is applying a moment to the engine case 200. Flanges oriented thusly may increase the case moment of inertia and reduce both case bending and out-of-round deflection. As a result, tip clearance may be more stringently maintained, thereby improving engine performance. The vertically oriented flanges may further provide ease of access during maintenance and reduce the effort required to retrieve fallen items that might be retained in a horizontally split case.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment. C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An engine case comprising:
a first half having a first semiannular geometry, with a first flange located at a first circumferential edge of the first half; and
a second half having a second semiannular geometry, with a second flange located at a second circumferential edge of the second half,
wherein the second flange is aligned with the first flange and mechanically coupled to the first flange,
wherein the first flange and the second flange substantially align with an engine mounting point,
wherein the engine case comprises an annular geometry.

2. The engine case of claim 1, wherein the engine case comprises a high pressure compressor case.

3. The engine case of claim 1, further comprising:
a third flange located at a third circumferential edge of the first half; and
a fourth flange located at a fourth circumferential edge of the second half, wherein the third flange is aligned with the fourth flange and mechanically coupled to the fourth flange.

4. The engine case of claim 3, further comprising:
a first seam defined by the first flange and the second flange; and
a second seam defined by the third flange and the fourth flange, wherein the first seam is substantially vertically aligned with the second seam.

5. The engine case of claim 1, further including a fastener mechanically coupling the first flange to the second flange.

6. The engine case of claim 3, wherein the first flange extends axially along the first half to define a first mating surface.

7. The engine case of claim 6, wherein the first mating surface and an engine centerline are coplanar.

8. The engine case of claim 6, wherein the third flange defines a second mating surface, wherein the second mating surface and the first mating surface are coplanar.

9. A gas turbine engine comprising:
a compressor section configured to rotate about an axis;
a combustor aft of the compressor section and in fluid communication with the compressor section;
a turbine section aft of the combustor and configured to extract energy from combusted gas;
an engine mounting point disposed on the gas turbine engine; and
an engine case disposed about at least one of the compressor section, the combustor section, or the turbine section, the engine case comprising a first half with a first upper flange and a second half with a second upper flange,
wherein the first upper flange is mechanically coupled to the second upper flange, and
wherein the first upper flange is substantially aligned with the engine mounting point.

10. The gas turbine engine of claim 9, further comprising:
a first lower flange extending from the first half of the engine case; and
a second lower flange extending from the second half of the engine case, wherein the first lower flange is mechanically coupled to the second lower flange.

11. The gas turbine engine of claim 10, wherein the first upper flange and the first lower flange are coplanar.

12. The gas turbine engine of claim 11, wherein the first upper flange is diametrically opposite the first lower flange.

13. The gas turbine engine of claim 9, wherein the first upper flange and the axis are coplanar.

14. The gas turbine engine of claim 9, wherein the engine case is at least partially disposed about a high pressure compressor of the compressor section.

15. The gas turbine engine of claim 9, wherein the first upper flange extends axially along an edge of the first half of the engine case.

16. The gas turbine engine of claim 15, wherein the first upper flange defines a mating surface.

17. A compressor section, comprising:
a high pressure compressor configured to rotate about an axis; and
a case having an annular geometry and disposed about the high pressure compressor,
wherein the case comprises a first half having a first flange extending axially and a second half having a second flange extending axially,
wherein the first flange is mechanically coupled to the second flange, and
wherein the first flange and the second flange are configured to substantially align with an engine mounting point.

18. The compressor section of claim 17, wherein the first flange is coplanar with the axis.

19. The compressor section of claim 17, further comprising:
a third flange extending axially along the first half; and
a fourth flange extending axially along the second half, wherein the third flange is mechanically coupled to the fourth flange.

20. The compressor section of claim 19, wherein the first flange is diametrically opposite the third flange.
